(19) United States
(12) Patent Application Publication
(10) Pub. No.: US 2013/0204689 A1
(43) Pub. Date: Aug. 8, 2013

(54) CONTROLLED DISTRIBUTION OF DIGITAL PAYLOADS

(71) Applicant: R-EVOLUTION INDUSTRIES LLC, KENMORE, WA (US)

(72) Inventors: JEREMY J. SCHULZ, KENMORE, WA (US); BRIAN P. MICHALSKI, REDMOND, WA (US); NICHOLAS A. VOGT, EVERETT, WA (US)

(73) Assignee: R-EVOLUTION INDUSTRIES LLC, KENMORE, WA (US)

(21) Appl. No.: 13/757,429

(22) Filed: Feb. 1, 2013

Related U.S. Application Data
(60) Provisional application No. 61/594,139, filed on Feb. 2, 2012.

(51) Int. Cl. G06Q 30/02

(52) U.S. Cl. CPC G06Q 30/0225
USPC 705/14.26

(57) ABSTRACT

Technologies related to controlled distribution of digital payloads are described. In some examples, unique identifiers may be generated for application to tangible articles. The unique identifiers may be linked to controllable digital payloads in a database. The controllable digital payloads may be redeemed by end users in response to end users supplying the unique identifiers to a controlled digital payload distribution system.

### CROSS-REFERENCE TO RELATED APPLICATIONS

Priority is claimed to U.S. Provisional Patent Application 61/594,139, entitled “UNIQUE PRODUCT SERIALIZATION FOR DIGITAL ASSET DISTRIBUTION”, filed on Feb. 2, 2012 and identified by attorney docket number REVO000200, which is incorporated by reference.

### BACKGROUND

Ecommerce, which includes for example online advertising and sales, digital offer distribution, and digital delivery of electronic goods such as software, songs, videos and the like, continues to rapidly evolve and increase in volume. The emergence of social media websites and mobile devices such as smart phones and tablet computers has recently driven many technological advances. There is an ongoing need to adapt and improve ecommerce to make it more relevant, more fun and engaging, and more profitable.

### SUMMARY

The present disclosure generally describes technologies including devices, methods, and computer readable media relating to technologies applicable to unique product serialization for digital asset distribution. Some example methods may be directed to controlled distribution of digital payloads by a controlled digital payload distribution system. Example methods may comprise customer interactions and end user interactions. Customer interactions may include receiving a digital payload by a controlled digital payload distribution system; generating, by the controlled digital payload distribution system, a unique identifier for application to a tangible article; linking the digital payload to the unique identifier in a database. End user interactions may comprise receiving, by the controlled digital payload distribution system, the unique identifier from an end user, wherein the end user acquired the unique identifier from the tangible article; receiving, by the controlled digital payload distribution system, end user account activation credentials from the end user; providing, by the controlled digital payload distribution system, the digital payload to the end user in response to an activation of the redemption control; and modifying the database, by the controlled digital payload distribution system, to indicate that the digital payload linked to the unique identifier is redeemed.

Example digital payloads may comprise a redeemable voucher, wherein the redeemable voucher is redeemable for a 1%-100% purchase price discount for a product or service, and/or a digital asset, wherein the digital asset comprises one or more of an audio, video, or software asset. Example unique identifiers, may comprise Quick Response (QR®) codes, bar codes, alphanumeric strings, or a Radio Frequency Identification (RFID) tags. Example tangible articles may comprise apparel, luggage, or pet collars.

Some example methods may comprise receiving, by the controlled digital payload distribution system, the unique identifier without end user account activation credentials, or receiving, by the controlled digital payload distribution system, the unique identifier after the digital payload is redeemed. The controlled digital payload distribution system may provide one or more secondary digital payloads to an end user in response to receiving the unique identifier when the digital payload is unredeemable.

Some example methods may comprise receiving, by the controlled digital payload distribution system, custom end user account content for the end user account; linking the unique identifier to the end user account in the controlled digital payload distribution system; and providing the custom end user account content to another end user in response to receiving the unique identifier after the digital payload linked to the unique identifier is redeemed. Some example methods may comprise providing one or more secondary digital payloads along with the custom end user account content.

Some example methods may comprise providing a customer account user interface adapted to receive the digital payload. The unique identifier may be provided in the customer account user interface. Some example methods may comprise receiving a subsequent digital payload, e.g., from a customer, for distribution by the controlled digital payload distribution system. The subsequent digital payload may be distributed to end user accounts associated with a previously redeemed digital payload. The controlled digital payload distribution system may provide a redemption control to the end user accounts for redeeming the subsequent digital payload.

Some example systems may comprise one or more networked computing devices, wherein the one or more networked computing devices comprise: one or more processors; one or more memories; and a controlled digital payload distribution system stored in the one or more memories and executable by the one or more processors, wherein the controlled digital payload system is configured to perform the methods described herein.

Computer readable media having instructions implementing the various technologies described herein, and tangible articles to which unique identifiers for controlled distribution of digital payloads are affixed are also disclosed. Example computer readable media may comprise non-transitory computer readable storage media having computer executable instructions executable by a processor, the instructions that, when executed by the processor, cause the processor to carry out any combination of the various methods provided herein. Example tangible articles may include any tangible article to which one or more unique identifiers linked to controllable digital payloads in accordance with this disclosure may be affixed.

Other features, objects and advantages of this disclosure will become apparent from the following description, taken in connection with the accompanying drawings, wherein, by way of illustration, example embodiments of the invention are disclosed.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram illustrating an example controlled digital payload distribution system.

FIG. 2 is a block diagram of a computing device as one example of a device configured to perform controlled distribution of digital payloads.

FIG. 3 is a flow diagram illustrating example methods for customer interactions.

FIG. 4 is a flow diagram illustrating example methods for end user interactions.

FIG. 5 is a diagram illustrating an example tangible article and unique identifiers.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure is generally drawn, inter alia, to technologies including methods, devices, systems and/or computer readable media deployed therein relating to controlled distribution of digital payloads. In some examples, unique product serialization may use QR® codes, RFID tags, serial numbers, bar codes, and/or other unique identifiers applied to tangible articles in connection with communications between end users, an intermediary that operates a controlled digital payload distribution system, and makers/sellers of products and services (referred to herein as “customers” because the makers/sellers of products and services may be customers of the intermediary).

The communications may be effective to initially generate unique identifiers which may be applied to tangible articles and to also associate the unique identifiers with controllable digital payloads. The communications may subsequently comprise receiving unique identifiers from end users, e.g., from end users that may have purchased tangible articles to which the unique identifiers were applied, and providing the controllable digital payloads to the end users. In one example method of controlling digital payloads, unique identifiers may be initially activated, prior to being redeemed by an end user, and subsequently deactivated after the unique identifiers are redeemed. Other methods of controlling digital payloads are also described herein.

The communications may furthermore comprise receiving and storing end user profile information, and optionally populating end user profile information with information pertaining to redeemed digital payloads and/or the associated tangible articles. In some embodiments, user profile information and/or digital payload redemption information may be stored and analyzed to assess end user behavior patterns.

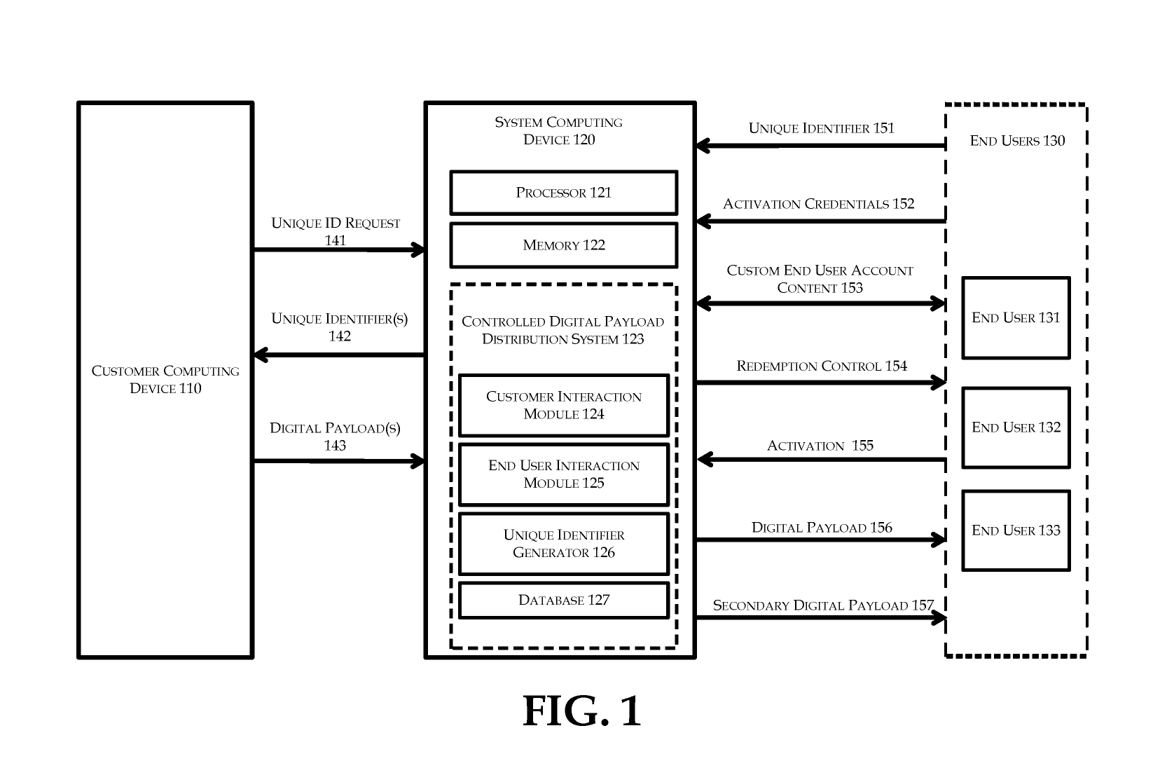

FIG. 1 is a block diagram illustrating an example payload distribution system, arranged in accordance with at least some embodiments of the present disclosure. FIG. 1 includes a customer computing device 110, a system computing device 120, and end users 130. System computing device 120 includes a processor 121, a memory 122, and a controlled digital payload distribution system 123. Controlled digital payload distribution system 123 includes a customer interaction module 124, an end user interaction module 125, a unique identifier generator 126, and a database 127. End users 130 include an end user 131, an end user 132, and an end user 133.

In some embodiments, a customer may use customer computing device 110 to interact with a controlled digital payload distribution system 123. The controlled digital payload distribution system 123 may be implemented within one or more networked computing devices, e.g., as a cloud service, ecommerce website, or other service. System computing device 120 may be located, for example, on one or more server computers, or within a virtual or cloud computing service platform. The customer may be, for example, a business such as a manufacturer or retailer of tangible articles, a musician or other artist, or a professional such as a lawyer, doctor, dentist, or other professional.

The controlled digital payload distribution system 123 (which may be referred to herein as the “system” 123) may comprise customer interaction module 124 configured to interact with customer computing device 110. Customer interaction module 124 may be adapted to receive customer requests for unique identifiers, such as unique ID request 141. In some embodiments, customer interaction module 124 may provide a customer account user interface, such as a web-based customer account user interface, adapted to provide account information and controls accessible from customer computing device 110. A customer account user interface may comprise, inter alia, controls for requesting unique identifiers, control for displaying generated unique identifiers, and/or controls for uploading and modifying digital payloads.

The system 123 may be configured to generate, in response to received customer requests 141, unique identifiers for application to tangible articles. For example, the system 123 may include unique identifier generator 126, which may be adapted to generate unique identifiers in response to requests from customer interaction module 124.

In some embodiments, the generator 126 may be adapted to generate unique identifiers such as QR® codes (also known as a quick response codes), barcodes, alphanumeric strings, RFID tags, two-dimensional codes, Near Field Communication (NFC) tags, biological IDs, or other unique identifiers which allow for unique and authentic one-to-one connections to end users, whether such other such unique identifiers are now known or may be developed in the future. In some embodiments, the generator 126 may be adapted to generate unique identifiers comprising machine or device readable codes or tags along with corresponding human-readable formats of the machine or device readable codes or tags. In some embodiments, generated unique identifiers may comprise sufficient length and complexity to deter or prevent “hacking” by unauthorized users. For example, in some embodiments, unique identifiers may comprise nine character strings containing a combination of digits and characters.

The system 123 may be configured to provide generated unique identifiers 142 to the customer 110. In some embodiments, the customer interaction module 124 may provide unique identifiers 142 to customers electronically, such as by providing electronic images of barcodes, QR® codes, alphanumeric strings, etc. to customer computing devices. In some embodiments, the system 123 may be configured to generate labels, tags, or other physical media comprising the unique identifiers 142, and to cause such physical media comprising the unique identifiers 142 to be delivered to a customer's physical address. In some embodiments, the system 124 may be configured to provide generated unique identifiers 142 to a customer designated affiliate, such as a manufacturer engaged by the customer to make tangible articles on the customer's behalf. In some embodiments, the system 123 may be configured to provide generated unique identifiers 142 to a printing subsystem to enable printing unique identifiers 142 directly on tangible articles or on heat transfer materials, labels, or other items adapted for application of unique identifiers 142 to tangible articles. In some embodiments, the system 123 may be adapted to require permanent, non-detachable printing of unique identifiers 142 on tangible articles.

In some embodiments, customer interaction module 124 may be configured to send unique identifiers 142 to a customer controlled account. The customer may optionally engage the service provider of system 123 or a third party to apply unique identifiers 142 to tangible articles. The customer account may be configured to allow customer-controllable modification of end user access to digital payloads, e.g., to change digital payloads redeemable using the unique identifiers 142, to add digital payloads redeemable using the unique identifiers 142, and/or to add or change digital payloads provided to end users subsequent to end user redemption of a digital payload.

In some embodiments, unique identifiers 142 may be applied to tangible articles by directly printing unique identifiers 142 on tangible articles, by otherwise permanently and non-detachably printing unique identifiers 142 on tangible articles, and/or by attaching removable tags or labels to tangible articles with unique identifiers printed on the tags or labels. One or multiple unique identifiers may be applied to tangible articles and one or multiple types of unique identifiers may be applied to tangible articles. For example, tag A may comprise a QR® code and tag B may comprise a barcode, and both tags may be applied to a same tangible article. One or more unique identifiers on one tangible article may comprise one or more human-readable unique identifiers and/or one or more machine-readable unique identifiers. Tangible articles may comprise any tangible article, including but not limited to apparel, luggage, pet collars, product packaging, electronic devices and/or electronic device covers, shoes, sporting goods, posters, game consoles, bags, cases, mobile phones, safety equipment, cards, tags, labels, credit cards, office accessories, sporting goods, toys, house wares, pet accessories, medical devices, medical equipment, and/or medications.

In some embodiments, the system 123 may be configured to receive customer requests 141 for unique identifiers by the customer interaction module 124 providing a customer user interface adapted for unique identifier requests 141. An example customer user interface may comprise a field for designating how many unique identifiers are to be generated and desired type(s) of unique identifiers, e.g., a barcode type, a QR® code type, alphanumeric strings, or otherwise.

The system 123 may be configured to receive digital payloads 143 from customers. The system 123 may be configured to receive digital payloads 143 for example by the customer interaction module 124 including a customer user interface adapted to receive digital payloads 143 from customer 110 and to store digital payloads 143 in a memory 122. Digital payloads 143 may comprise, for example, electronic files comprising redeemable vouchers or coupons, wherein the redeemable vouchers are redeemable for a 1% to 100% purchase price discount for a product or service. In some embodiments, digital payloads 143 may comprise digital media assets, such as albums, songs, audio files, videos, photographs, books, movies, software or other digital media. In some embodiments, digital payloads 143 may comprise trial offers, lotteries, surveys, product information, and/or invitations. In some embodiments, digital payloads 143 may comprise Uniform Resource Locators (URLs), phone numbers, or other information to enable communication between end users 130 and customers or other businesses via voice, digital messaging, and/or other forms of communication. In some embodiments, digital payloads 143 may comprise rebates, coupons, surveys, social media access or connectivity, incentives, event access, cash like or cash equivalent units, tickets, ecommerce offers, product promotions, product samples, mobile games, mobile applications, proprietary data, educational data, white papers, training, online classes, credits, cell phone time, sneak previews, and/or sample content.

The system 123 may be configured to link generated unique identifiers 142 with received digital payload(s) 143 in a database 127 accessible by the system 123. For example, the system 123 may be configured to assign payload identifiers to digital payloads 143, and to link payload identifiers, in the database 127, with corresponding generated unique identifiers 142 for tangible articles.

In some embodiments, the system 123 may be configured to receive digital payloads 143 directly from customer computing devices 110. In some embodiments, an operator of the system 123 may receive digital payloads 143 in physical form, such as by receiving a Compact Disk (CD), Digital Versatile Disk (DVD) or other physical media from a customer, and the operator may load digital payloads 143 into the system 123. The system 123 may receive one or multiple digital payloads 143, and the one or multiple digital payloads 143 may be linked to one or multiple unique identifiers 142. Unique identifiers 142 may be activated and deactivated, e.g., by flagging the unique identifiers 142 as active or inactive in the database 127. Unique identifiers 142 may be activated and deactivated individually or in batches, by operators of the system 123. In some embodiments, the system 123 may expose an interface allowing unique identifiers 142 to be activated and deactivated, individually or in batches, via customer interactions with customer interaction module 124.

The controlled digital payload distribution system 123 may furthermore be configured to interact with end users 130. Example end users 130 may comprise purchasers of tangible articles or persons who may have otherwise acquired or gained access to tangible articles, e.g., consumers, music fans, concert-goers, pet-owners, and/or businesses. In some embodiments, the system 123 may be configured to interact with end user computing devices, e.g., Personal Computer (PC), laptop, and/or mobile devices operated by end users 130, by including an end user interaction module 125 adapted to provide end user interfaces configured to receive user account activation credentials 152 and/or unique identifiers 151 from an end user 131; to provide a redemption control 154 to the end user 131; to receive an activation 155 of the redemption control 154 from the end user 131; and/or to provide a digital payload 156 to the end user 131 in response to the activation 155. System 123 may furthermore be configured to modify the database 127 by to indicate that a digital payload linked to a received unique identifier 151 is redeemed.

End user interfaces may also comprise a variety of other features disclosed herein, including for example, interfaces adapted to receive custom end user account content 153, such as end user status information, end user pictures, descriptions of tangible articles and/or digital payloads purchased or redeemed by the end users 131, end user 131 comments on such tangible articles and/or digital payloads, and/or comments from other end users 132, 133, such as friends or associates of end user 131, who may be linked to end user 131 in a social graph.

In some embodiments according to FIG. 1, end user 131, who has acquired a unique identifier 151 from a tangible article to which unique identifiers 142 were applied, may send unique identifier 151 to system 123. End user 131 may send unique identifier 151 for example by scanning or photographing unique identifier 151 with an end user computing device and sending the resulting image to system 123, by typing a human-readable format of unique identifier 151 into a field provided in web page or other interface provided by end user interaction module, or otherwise.

End user interaction module 125 may be configured to receive unique identifier 151. End user interaction module 125 may also be configured to request and receive end user account activation credentials 152, such as an end user's username and password. When end user interaction module 125 receives unique identifier 151 from end user 131, end user interaction module 125 may be configured to check whether activation credentials from end user 131 were received. If activation credentials 152 were received, end user interaction module 125 may be configured to send redemption control 154 to end user 131. Redemption control 154 may be configured to comprise a control by which end user 131 may activate, via activation 155, the redemption of the digital payload linked to unique identifier 151. When end user 131 activates redemption control 154, end user interaction module 125 may be configured to receive activation 155 and provide digital payload 156 to end user 131. End user interaction module 125 may be configured to modify database 127 to indicate that the digital payload 156 linked to unique identifier 151 is redeemed.

If no activation credentials were received at system in connection with the end user session in which unique identifier 151 is supplied to end user interaction module 125, end user interaction module 125 may be configured to send a request for end user account activation credentials 152 and/or to request the end user to set up a new end user account. After account credentials are received, the redemption control 154 and digital payload 156 may be provided to the end user as described above.

In some embodiments according to FIG. 1, any of end users 130 may set up an end user account, with or without having a unique identifier 151. An end user 131 may for example set up an end user account in a first session with user interaction module 125, and may, in the first session or thereafter, establish connections between end user's 131 account and other end user accounts, e.g., with end user's 132 and 133 accounts. End user 131 may also provide custom end user account content 153 to end user's 131 account. End user 131 may then provide unique identifier 151 as well as account activation credentials 152, such as username and password, in a subsequent session with user interaction module 125.

End user interaction module 125 and/or other modules within system 123 may be configured to receive custom end user account content 153 and to link end user accounts to received unique identifiers, such as unique identifier 151, or customers, tangible articles, and/or digital assets associated with received unique identifiers. For example, system 123 may be configured to store a profile for each end user. End users may establish connections with one another in a social graph by sending/approving connection requests, allowing end users to see each other's profiles. System 123 may be configured to automatically populate end user profiles with information relating to tangible articles, digital payloads, and/or customers associated with unique identifiers received from end users. In some embodiments, for example, system 123 may be configured to automatically populate end user profiles with links to tangible articles, allowing those viewing an end user's profile to access customer information about the tangible articles and/or digital assets available from customers in connection with the tangible articles. End user profiles may be customized by, e.g., end user comments on tangible articles associated with redeemed unique identifiers, and/or end user comments on corresponding redeemed digital assets.

It is likely that, in connection a system 123 according to FIG. 1, an end user may supply a same unique identifier 151 to system 123 more than once, or may not wish to set up an account to establish credentials to redeem a digital asset. For example, end user 131 may forget that digital payload 156 was previously redeemed, end user 131 may wish to obtain a second copy of digital payload 156, or another end user, such as end user 132 or end user 133, may gain access to unique identifier 151 and may provide unique identifier 151 to system 151 after digital payload 156 was redeemed by end user 131. Such usage scenarios may generally comprise receiving by the system 123 the unique identifier 151 when the digital payload 156 is unredeemable, such as by receiving by the system 123 the unique identifier 151 without end user account activation credentials 152, or receiving by the system 123 the unique identifier 151 after the digital payload 156 is redeemed with unique identifier 151. In such scenarios, system 123 may be configured to provide one or more secondary digital payloads 157 to an end user in response to receiving the unique identifier 151 when the digital payload 156 is unredeemable.

Secondary digital payloads 157 may for example be received among digital payloads 143 for use in the context of secondary payload usage scenarios. Secondary digital payloads 157 may be flagged as secondary or otherwise identified, and “primary” digital payloads may also be identified, so that the primary and secondary digital payloads may be appropriately distributed to end users. As with primary digital payloads, secondary digital payloads 157 may be controllable via customer interaction with customer interaction module 124, e.g., to modify, replace, or add secondary payloads to be distributed by system 123.

In an example use case, end user 132 may comprise an end user who saw end user 131 wearing or carrying a tangible article with an applied unique identifier 151. End user 132 may send unique identifier 151 as described above to system computing device 120. End user interaction module 125 may be configured to receive unique identifier 151 from end user 132 and check whether the digital payload linked with unique identifier 151 has been redeemed. Database 127 may be configured to indicate that the digital payload linked with unique identifier 151 has been redeemed by end user 131 and is no longer redeemable. For unredeemable digital payloads, end user interaction module 125 may be configured to send one or more secondary digital payloads 157 to end user 132, wherein the one or more secondary digital payloads 157 may comprise product/service information, a sample, and/or a digital payload of lesser value than digital payload 156. Custom end user account content 153 linked to end user 131, whose end user account is linked to the primary digital payload linked to unique identifier 151, may also be configured to be sent when a digital payload 156 is unredeemable.

It is also likely that, in connection a system 123 according to FIG. 1, it may be convenient for end users to use unique identifiers to facilitate connecting with each other. System 123 may be configured to facilitate end user connections, for example, by receiving, by the system 123 custom end user account content for 153 for an end user account, such as for end user 131; linking a unique identifier 151 to the end user 131 account in the system 123, e.g., in connection with end user 131 redeeming digital payload 156; and providing the custom end user account content 153 to an end user such as end user 132 in response to receiving the unique identifier 151, e.g., from end user 132 after the digital payload 156 linked to the unique identifier 151 is redeemed. In other words, the custom end user account content 153 for the end user 131 that redeemed the digital payload 156 with unique identifier 151 can be provided to other end users 132, 133 in response to end users 132, 133 submitting unique identifier 151 to system 123. In some embodiments, the system 123 may furthermore be configured to provide secondary digital payloads 157 to end users 132, 133 along with the profile/custom content 153 for end user 131.

In some embodiments, system 123 may be configured to distribute subsequent digital payloads to end users. For example, a customer may supply a subsequent digital payload to system 123, for distribution by system 123 to end users, such as end user 131, which previously redeemed digital payloads such as digital payload 156. System 123 may provide subsequent digital payloads and/or links thereto in end user profiles or otherwise in end user accounts, to be redeemed by end users. System 123 may notify end users of the availability of subsequent digital payloads for example by email, text message, telephone call, or otherwise. In some embodiments, system 123 may provide subsequent digital payloads and/or links thereto to end users 123 by attaching the subsequent digital payloads to emails, texts, or other electronic communications to end users. In some embodiments, in response to receiving a subsequent digital payload for distribution to end user accounts associated with a previously redeemed digital payload, the system 123 may be configured to provide a redemption control to end user accounts for redeeming the subsequent digital payload.

In some embodiments, system 123 may be configured to generate primary and secondary unique identifiers for customers, and to distribute corresponding primary and secondary digital payloads to end users 130. For example, primary unique identifiers may be configured as “single-use” unique identifiers providing an end user an opportunity to redeem a valuable digital asset, such as a full album. Secondary unique identifiers may be configured as “unlimited-use” unique identifiers providing end users unlimited opportunities to redeem a less valuable digital asset, such as a single song from an album. In its interactions with a customer, and in addition to implementing the operations described herein in connection with “primary” digital payloads, system 123 may receive a secondary digital payload (in addition to the primary digital payload) from customer computing device 110; generate secondary unique identifiers for application to tangible articles; and/or link the secondary digital payloads to the secondary unique identifiers in the database. In its interactions with end users, system 123 may receive a secondary unique identifier from an end user, wherein the end user acquired the secondary unique identifier from the tangible article; provide a redemption control to the end user; and provide the secondary digital payload to the end user in response to an activation of the redemption control.

In some embodiments, system 123 may be configured to receive and store date and/or time of sale or distribution information for tangible articles comprising generated unique identifiers 142. For example, unique identifiers 142 may be scanned at point of purchase of tangible articles, date and time of sale or distribution information may be sent to a sales information interface (not shown) provided by system 123.

In some embodiments, system 123 may be configured to store date and time of end user redemptions of primary and/or secondary digital payloads. System 123 may provide, e.g., within customer account interfaces, tools to view, measure, group, and/or analyze patterns of end user behavior, such as average times between purchase of a tangible article and redemption of digital payloads, rates digital payload redemption, rates of secondary digital payload redemption, and/or times between primary and secondary digital payload redemption.

In some embodiments, an end user mobile software application may be designed to run on portable computing devices, wherein the end user mobile software application may be configured to acquire unique identifiers from tangible articles and to interact with system 123 to redeem digital assets. An end user mobile software application may enhance the end user experience and provide additional services that may benefit from specific functionality on a portable computing device. The end user mobile application may also allow end users to redeem digital payloads by supporting manual entry of unique identifiers in an application interface. System 123 may be configured with an end user mobile software application interface (not shown) to support application-based interactions between end users and system 123.

In some examples, customers may comprise musicians. Customer interaction module 124 may be configured to enable musicians to “package” their music and/or other digital assets as digital payloads which may be accessed by end users with tangible articles comprising musician's merchandised apparel or collectibles, wherein the sale of tangible articles may be a vehicle for distribution of the artist's music and may eliminate certain intermediary steps frequently involved in the music industry.

In some embodiments, tangible articles comprising musicians' shirts may comprise a plurality of unique identifiers, wherein the unique identifiers provide access to digital payloads comprising downloadable or streamed audio, video, art and other digitally distributed media assets provided by system 123. A primary unique identifier may be applied on the interior of the shirt may be configured as a single-use unique identifier providing the fan end user who acquired the shirt with a digital payload comprising a digital coupon or discount for a music album. A secondary unique identifier applied on the exterior of the shirt may encode a digital payload comprising a URL for the musician and sample music, which may be accessed multiple times by end users who see the fan wearing the shirt.

Another example customer utilizing system 123 may comprise a pet store merchant. Customer interaction module 124 may be configured to enable pet stores to “package” digital payloads directly with their merchandised pet products. In some embodiments, tangible articles may comprise pet collars to which unique identifiers 142 may be applied. The unique identifiers 142 may provide end users with access to digital payloads comprising downloadable rebates for pet products, services, and/or other digitally distributed assets. End user profile information, which may be accessible using activation credentials 152, a unique identifier 151 and/or a secondary unique identifier as described herein, may comprise pet name, pet pictures, and/or pet owner contact information, which may be useful in the event that a pet is lost. The pet store may furthermore provide subsequent digital payloads to end users, the subsequent digital payloads comprising coupons for pet products and/or services the pet uses, e.g., groomer, food brands, and favorite treats.

Another example customer utilizing system 123 may comprise a nonprofit organization. Customer interaction module 124 may be configured to enable a nonprofit organization to “package” digital payloads comprising information about the organization's mission, requests for donations, and/or gifts to acknowledge charitable contributions with tangible articles distributed by the nonprofit. In some embodiments, unique identifiers 142 may be applied to tangible articles comprising, e.g., canvas bags with the nonprofit's logo. The unique identifiers 142 may provide access to digital payloads comprising coupons redeemable at businesses supporting the nonprofit, as well as the nonprofit organization's URL. Secondary unique identifiers applied on the exterior of the canvas bag may correspond to secondary digital payloads comprising, e.g., a URL for the nonprofit organization and a request for donations, which may be accessed multiple times by others who see the secondary unique identifiers on the canvas bags.

In some embodiments, customer interaction module 124 may provide customer account user interfaces that include selectable categories of tangible articles. Selectable categories may include selectable sub-categories. For example, customer account user interfaces may include selectable product line categories, and the selectable product line categories may include selectable product batch categories. Selection of a product line category may be effective to display related product batch categories. Selection of a product batch category may be effective to display end user data for end users that redeemed digital payloads associated with the product batch. End user data may comprise, inter alia, end user name and geographic/demographic information. End user data may comprise end user tangible article purchase and/or digital payload redemption information for any other of the customer's products, e.g., identifications of article purchased/payloads redeemed, and location/time of purchase or redemption. End user data may comprise numbers of end user connections (other end users whose accounts are connected to an end user), and/or number of end user connections who purchased the customer's products.

In some embodiments, end user interaction module 125 may provide end user account user interfaces that include categories of tangible articles. In some embodiments, separate end user “profiles” may be created automatically by system 123 for each tangible article acquired by an end user, as identified from a received unique identifier 151. In some embodiments, separate end user “profiles” may be created automatically by system 123 for categories of tangible articles, e.g., for all tangible articles associated with a particular customer. In some embodiments, system 123 may support the creation by end users of separate end user “profiles” for individual tangible articles or categories of tangible articles. A user account view may display one or more selectable profiles, and the end user may view information relating to the tangible article by selecting a profile. Information relating to the tangible article may include, inter alia, redeemed digital payloads, subsequent digital payloads made available by the customer, end user comments on the tangible article, etc.

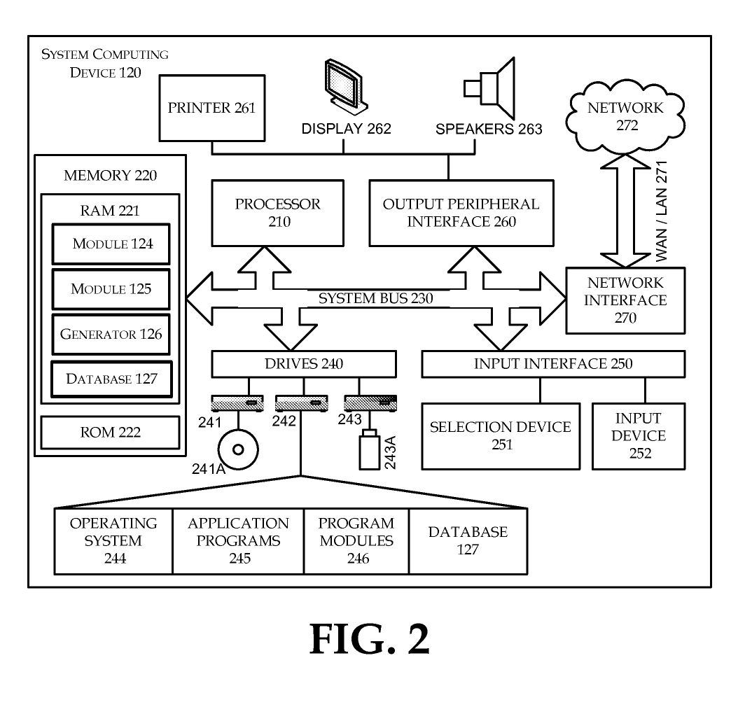

FIG. 2 is a block diagram illustrating an example computing device as one example of a computing device configured to perform controlled distribution of a digital payload by a controlled digital payload distribution system, arranged in accordance with at least some embodiments of the present disclosure. In FIG. 2, system computing device 120 may include for example a processor 210, memory 220, system bus 230, one or more drives 240, user input interface 250, output peripheral interface 260, and network interface 270.

Drives 240 may include, for example, a compact disk drive 241 which accepts an optical disk 241A, a so-called hard drive 242, which may employ any of a diverse range of computer readable media, and a flash drive 243 which may employ for example a Universal Serial Bus (USB) type interface to access a flash memory 243A. Drives may further include network drives and virtual drives (not shown) accessed via the network interface 270.

The drives 240 and their associated computer storage media provide storage of computer readable instructions, data structures, program modules and other data for the computer system 200. For example, a hard drive 242 may include an operating system 244, application programs 245, program modules 246, and database 147. Software aspects of the technologies described herein may be implemented, in some embodiments, as computer readable instructions stored on any of the drives 240 or on network 272, which instructions may be loaded into memory 220, for example as modules 124, 125, generator 126, and database 127, described in connection with FIG. 1, and executed by processor 210.

Computer system 200 may further include a wired or wireless input interface 250 through which selection devices 251 and input devices 252 may interact with the other elements of the system 200. Selection devices 251 and input devices 252 can be connected to the input interface 250 which is in turn coupled to the system bus 230, allowing devices 251 and 252 to interact with processor 210 and the other elements of the system 200. Interface and bus structures that may be utilized to implement 250 may include for example a Peripheral Component Interconnect (PCI) type interface, parallel port, game port and a wired or wireless Universal Serial Bus (USB) interface.

Selection devices 251 such as a mouse, trackball, touch screen, or touch pad allow a user to select among desired options that may be output by the system 200, for example via the display 262. Input devices 252 can include any devices through which commands and data may be introduced to the system 200. Exemplary input devices 252 include a keyboard, an electronic digitizer, a microphone, a joystick, game pad, satellite dish, scanner, media player, mobile device, or the like.

Computer system 200 may also include an output peripheral interface 260 which allows the processor 210 and other devices coupled to bus 230 to interact with peripheral output devices such as printer 261, display 262, and speakers 263. Interface and bus structures that may be utilized to implement 260 include those structures that can be used to implement the input interface 250. It should also be understood that many devices are capable of supplying input as well as receiving output, and input interface 250 and output interface 260 may be dual purpose or support two-way communication between components connected to the bus 230 as necessary.

System computing device 120 may operate in a networked environment using logical connections to one or more computers. By way of example, FIG. 2 shows a LAN 271 connection to a network 272. A remote computer may also be connected to network 271. The remote computer may be a personal computer, a server, a router, a network PC, a peer device or other common network node, and can include many or all of the elements described above relative to computing system 200.

Networking environments are commonplace in offices, enterprise-wide area networks (WAN), local area networks (LAN), intranets and the Internet. For example, in the subject matter of the present application, system computing device 120 may comprise the source machine from which data is migrated, and the remote computer may comprise the destination machine, or vice versa. Note however, that source and destination machines need not be connected through a network 272, but instead, data may be migrated via any media capable of being written by the source platform and read by the destination platform or platforms.

When used in a LAN or WLAN networking environment, system computing device 120 is connected to the LAN through a network interface 270 or an adapter. When used in a WAN networking environment, system computing device 120 typically includes a modem or other means for establishing communications over the WAN, such as the Internet or network 272. It will be appreciated that other means of establishing a communications link between computers may be used.

According to one embodiment, system computing device 120 is connected in a networking environment such that the processor 210 and/or modules 223 can perform appropriate processes and implement features in accordance with embodiments herein.

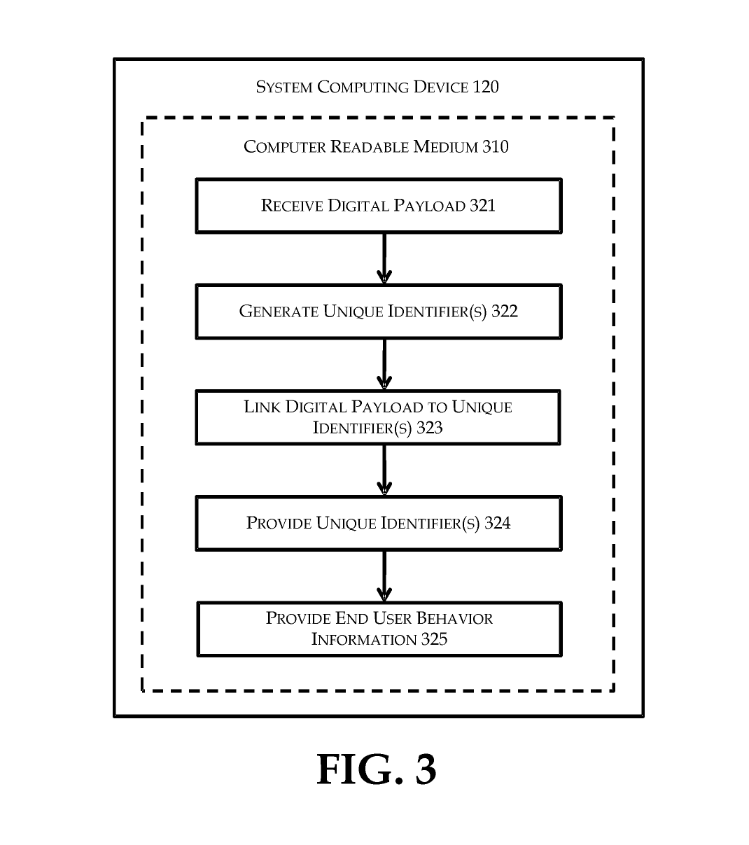

FIG. 3 is a flow diagram illustrating example methods for customer interactions, arranged in accordance with at least some embodiments of the present disclosure. The example flow diagram may include one or more operations/modules as illustrated by blocks 321-325, which represent operations as may be performed in a method, functional modules in a system computing device 120, and/or instructions as may be recorded on a computer readable medium 310. The illustrated blocks 321-325 may be arranged to provide functional operations of “Receive Digital Payload” at block 321, “Generate Unique Identifier(s)” at block 322, “Link Digital Payload to Unique Identifier(s)” at block 323, “Provide Unique Identifier(s)” at block 324, and “Provide End User Behavior Information” at block 325.

In FIG. 3, blocks 321-325 are illustrated as including blocks being performed sequentially, e.g., with block 321 first and block 325 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

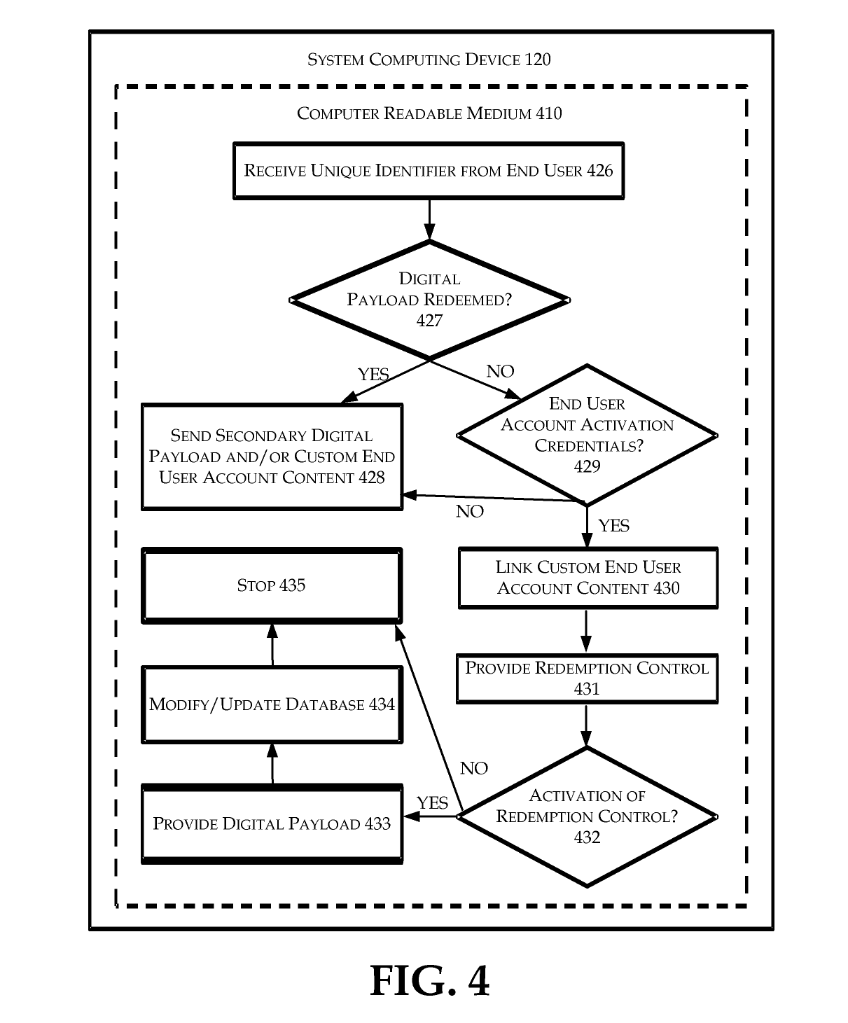

FIG. 3 illustrates an example method by which computing device 120 may interact with a customer computing device 110 to implement controlled distribution of a digital payloads. In a “Receive Digital Payload” block 321, the customer interactions module in system computing device 120 may receive one or more digital payloads. Customer interactions module may receive the one or more digital payloads directly from a customer computing device, or a service provider may receive it from a customer and upload it into system computing device 120. The one or more digital payloads may comprise one or more of a redeemable voucher, trial offer, lotteries, give-away, survey, social medial access, event access, invite, ticket, product/service offer, product/service sample, product/service information, and sample. The digital payload may comprise a digital asset, wherein the digital asset may comprise one or more of an album, song, video, book, movie, software, game, application, information, data, or product/service credit. In some embodiments, block 321 may be allow for receiving replacement digital payloads at any time before, during or after operations according to FIG. 3 or FIG. 4. In some embodiments, block 321 may comprise receiving “primary” as well as “secondary” digital payloads. In some embodiments, block 321 may comprise receiving subsequent digital payloads for distribution to end users as described herein.

In a “Generate Unique Identifier(s)” block 322, the unique identifier generator in system computing device 120 may generate one or more unique identifiers for application to tangible articles. The unique identifiers may be configured to comprise, for example, QR® codes, barcodes, alphanumeric strings, RFID tags, machine readable codes or tags accompanied by human-readable formats of the same code or tag, NFC tags, and/or biological IDs. In some embodiments, the unique identifiers may comprise sufficient length and complexity to deter or prevent “hacking” by unauthorized users. In some embodiments, block 322 may comprise generating pairs of unique identifiers, each pair comprising a “primary” and a “secondary” unique identifier, wherein each pair of primary and secondary unique identifiers are for application to a single tangible article and wherein primary unique identifiers are linked to primary digital payloads in block 323, and wherein secondary unique identifiers are linked to secondary digital payloads in block 323.

In a “Link Digital Payload to Unique Identifier(s)” block 323, system computing device 120 may store in a database the one or more unique identifiers and the one or more digital payloads, and link the one or more unique identifiers with the one or more digital payloads. The one or more digital payloads may be linked to a single unique identifier or group of unique identifiers. For example, unique identifiers may be grouped according to the types of tangible articles to which the unique identifiers will be applied. Different types of tangible articles sold by a customer may be associated with different digital assets. Linking digital payloads to unique identifiers may comprise linking primary and secondary unique identifiers with primary and secondary digital payloads as described herein.

In a “Provide Unique Identifier(s)” block 324, unique identifiers generated by system computing device 120 may be, for example, sent to a customer computing device 110 or placed in a customer account. Alternatively, a customer may direct the service provider of system computing device 120 or a third party to apply the generated unique identifiers to tangible articles—e.g., in cases where the service provider also provides manufacturing services or has manufacturing affiliates.

In a “Provide End User Behavior Information” block 325, system computing device 120 may provide, e.g., to customer computing device 110, information such as unique identifier information, digital payload information, and end user behavior information comprising dates of distribution, sale, and digital payload redemption. A service provider and/or customer may use this database information to analyze end user behavior and strategize the customer's business practices.

FIG. 4 is a flow diagram illustrating example methods for end user interactions, arranged in accordance with at least some embodiments of the present disclosure. The example flow diagram may include one or more operations/modules as illustrated by blocks 426-435, which represent operations as may be performed in a method, functional modules in a system computing device 120, and/or instructions as may be recorded on a computer readable memory 410. The illustrated blocks 426-435 may be arranged to provide functional operations of “Receive Unique Identifier from End User” at block 426, “Digital Payload Redeemed?” at decision block 427, “Send Secondary Digital Payload and/or Custom End User Account Content” at block 428, “End User Account Activation Credentials?” at decision block 429, “Link Custom User Account Content” at block 430, “Provide Redemption Control” at block 431, “Activation of Redemption Control?” at decision block 432, “Provide Digital Payload” at block 433, “Modify/Update Database” at block 434, and “Stop” at block 435.

In FIG. 4, blocks 426-435 are illustrated as including blocks being performed sequentially, e.g., with block 426 first and block 435 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 4 illustrates example methods by which computing device 120 may interact with end users. It will be appreciated that in some embodiments, prior to the operations illustrated in FIG. 4, and end user may initially set up an end user account as described herein, and may establish account activation credentials, such as a username and password, during account setup. In some embodiments, end user account setup operations may occur as one or more intermediate operations among the operations illustrated in FIG. 4.

In a “Receive Unique Identifier from End User” block 426, the end user interactions module in system computing device 120 may receive a unique identifier from an end user who has acquired a unique identifier from a tangible article. For example, the end user may send a unique identifier by scanning it using a smart phone or other portable computing device equipped with a camera using available camera and/or scanning applications. The end user's device may provide the unique identifier to a network API and/or navigate to a URL encoded into the unique identifier using the portable computing device's internet capabilities. This URL, which may incorporate a unique identifier, may entitle the end user to receive one or more digital payloads. The end user may also manually open a browser on a computing device, navigate to the service provider's web site, and manually enter the unique identifier displayed in human readable form

In a “Digital Payload Redeemed?” decision block 427, the end user interaction module may be configured to check whether the digital payload linked to a unique identifier has been redeemed. If the digital payload has been redeemed, the digital payload may be flagged in the database as such, such as by flagging the digital payload as “unredeemable”. Block 427 may be followed by block 428 when the digital payload is flagged as unredeemable or otherwise deactivated. If the digital payload has not been redeemed, and therefore remains redeemable, then block 429 follows.

In a “Send Secondary Digital Payload and/or Custom End User Account Content” block 428, the end user interactions module may be configured to send the end user one or more of a secondary digital payload or custom end user account content associated with end user who has redeemed the digital payload linked to the unique identifier.

In an “End User Account Activation Credentials?” decision block 429, the end user interactions module may be configured to check whether end user account activation credentials were sent by the end user. If the end user has not provided end user account activation credentials, then block 428 may follow. If the end user has provided end user account activation credentials, then block 430 may follow.

In a “Link Custom User Account Content” block 430, the end user interactions module may be configured to receive custom end user account content and link such content to the unique identifier. Custom end user account content may be sent when an end user creates an account and/or enters custom end user content, such as the end user's desired username and/or any other content. The end user interactions module may be configured to store the custom end user content and its linkage to the unique identifier in an accessible user profile database. In some embodiments, block 430 may be executed in conjunction with block 426.

In a “Provide Redemption Control” block 431, the end user interactions module may be configured to provide a redemption control to the end user. The redemption control provides the end user with the option to activate the redemption control to redeem the digital payload associated with the unique identifier.

In an “Activation of Redemption Control?” decision block 432, the end user interactions module checks for activation of the redemption control by the end user, or otherwise receives a redemption command from the end user. If the redemption control has not been activated, then block 435 follows. If the redemption control has been activated, then block 433 follows.

In a “Provide Digital Payload” block 433, the end user interactions module provides the digital payload linked to the unique identifier to the end user. The digital payload may be provided for example by downloading the digital payload to the end user's mobile or other computing device, in response to the activation at block 432. In some embodiments, a download control may be provided in response to the activation at block 432, and download may be initiated in response to user activation of the download control. The digital payload may instead or additionally be provided for example by email, text, or by posting the digital payload or a link thereto in an end user account, so that end users may download the digital payload from their end user account interface, without necessarily re-entering the unique identifier at any time after the digital payload is redeemed.

In a “Modify/Update Database” block 434, the end user interactions module modifies the database to indicate that the digital payload linked to the unique identifier has been redeemed. Block 433 may be executed in conjunction with block 434. In a “Stop” block 435, the end user interactions module may be configured to stop, e.g., upon end user logout.

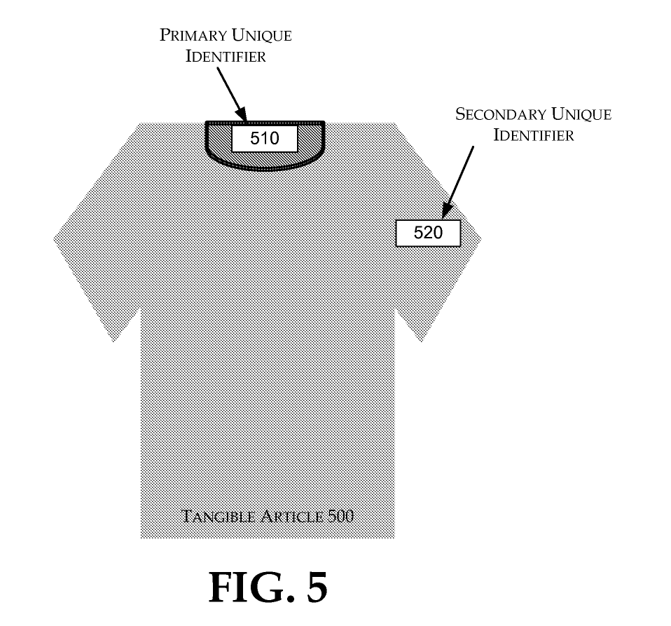

FIG. 5 is a diagram illustrating an example tangible article, arranged in accordance with at least some embodiments of the present disclosure. FIG. 5 includes a tangible article 500, a primary unique identifier 510, and a secondary unique identifier 520, wherein the primary and secondary unique identifiers are linked to controllable digital payloads in accordance with the teachings herein.

In FIG. 5, tangible article 500 is a shirt, however it will be understood that tangible article 500 may comprise virtually anything including but not limited to a book, bag, apparel, pet collar, card, device, or packaging. Primary unique identifier 510 may be associated with a primary digital payload. Secondary unique identifier 520 may be associated a secondary digital payload. In some embodiments, secondary unique identifier 520 may be, for example, applied in a prominent location on tangible article 500 for open access, whereas primary unique identifier 510 may be applied in a more concealed area, such as the interior of tangible article 500, for limited access to the end user who acquired tangible article 500.

One or more of primary unique identifier 510 and/or secondary unique identifier 520 may be applied to tangible article 500. For example, in some embodiments, only primary unique identifier 510 may be applied to tangible article 500, without secondary unique identifier 520. Primary unique identifier 510 may be applied either in a concealed area such as illustrated in FIG. 5 or in a prominent location on tangible article 500, e.g., in the location occupied by secondary unique identifier 520. Also, primary and secondary unique identifiers need not necessarily be applied to a same tangible article. In some embodiments, primary unique identifiers may be applied to some tangible articles, while secondary unique identifiers may be applied to other tangible articles. In some embodiments, primary and secondary unique identifiers may be applied to related articles, such as by applying a primary unique identifier to a baseball glove and a secondary unique identifier to a baseball which may be sold with the baseball glove.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely examples and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly inter-actable and/or wirelessly interacting components and/or logically interacting and/or logically inter-actable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method for controlled distribution of a digital payload by a controlled digital payload distribution system, comprising:
receiving the digital payload at the controlled digital payload distribution system;
generating by the controlled digital payload distribution system a unique identifier for application to a tangible article;
linking the digital payload to the unique identifier in a database;
receiving by the controlled digital payload distribution system the unique identifier from an end user, wherein the end user acquired the unique identifier from the tangible article;
receiving by the controlled digital payload distribution system end user account activation credentials from the end user;
providing by the controlled digital payload distribution system a redemption control to the end user;
providing by the controlled digital payload distribution system the digital payload to the end user in response to an activation of the redemption control; and
modifying the database by the controlled digital payload distribution system to indicate that the digital payload linked to the unique identifier is redeemed.

2. The method of claim 1, wherein the digital payload comprises:
a redeemable voucher, wherein the redeemable voucher is redeemable for a 1%-100% purchase price discount for a product or service;
a digital asset, the digital asset comprising one or more of an audio, video, or software asset.

3. The method of claim 1, wherein the unique identifier comprises a QR Code®, a bar code, an alphanumeric string, or an RFID tag.

4. The method of claim 1, wherein the tangible article comprises apparel, luggage, or a pet collar.

5. The method of claim 1, further comprising:
receiving by the controlled digital payload distribution system the unique identifier when the digital payload is unredeemable, comprising:
receiving by the controlled digital payload distribution system the unique identifier without end user account activation credentials; or
receiving by the controlled digital payload distribution system the unique identifier after the digital payload is redeemed; and
providing by the controlled digital payload distribution system one or more secondary digital payloads to an end user in response to receiving the unique identifier when the digital payload is unredeemable.

6. The method of claim 1, further comprising:
receiving by the controlled digital payload distribution system custom end user account content for the end user account;
linking the unique identifier to the end user account in the controlled digital payload distribution system; and
providing the custom end user account content to an end user in response to receiving the unique identifier after the digital payload linked to the unique identifier is redeemed.

7. The method of claim 6, further comprising providing one or more secondary digital payloads along with the custom end user account content.

8. The method of claim 1, further comprising providing a customer account user interface adapted to receive the digital payload.

9. The method of claim 8, further comprising providing the unique identifier in the customer account user interface.

10. The method of claim 8, wherein the customer account user interface is adapted to provide one or more selectable product lines of tangible articles, one or more selectable batches of tangible articles for at least one of the product lines, and end user information for at least one of the batches.

11. The method of claim 1, further comprising providing an end user account user interface comprising selectable tangible articles and/or selectable categories of tangible articles corresponding to digital payloads redeemed by the end user.

12. The method of claim 1, further comprising:
receiving a subsequent digital payload for distribution by the controlled digital payload distribution system to end user accounts associated with a previously redeemed digital payload; and
providing by the controlled digital payload distribution system a redemption control to the end user accounts for redeeming the subsequent digital payload.

13. The method of claim 1, further comprising:
receiving a secondary digital payload at the controlled digital payload distribution system;
generating by the controlled digital payload distribution system a secondary unique identifier for application to the tangible article;
linking the secondary digital payload to the secondary unique identifier in the database;
receiving by the controlled digital payload distribution system the secondary unique identifier from an end user, wherein the end user acquired the secondary unique identifier from the tangible article;
providing by the controlled digital payload distribution system a redemption control to the end user; and
providing by the controlled digital payload distribution system the secondary digital payload to the end user in response to an activation of the redemption control.

14. The method of claim 1, further comprising providing, by the controlled digital payload distribution system, an end user

15. A controlled digital payload distribution system comprising one or more networked computing devices, the one or more networked computing devices comprising:
one or more processors;
one or more memories; and
a controlled digital payload distribution system stored in the one or more memories and executable by the one or more processors, wherein the controlled digital payload distribution system is configured to:
receive a digital payload;
generate a unique identifier for application to a tangible article;
link the digital payload to the unique identifier in a database;
receive the unique identifier from an end user, wherein the end user acquired the unique identifier from the tangible article;
receive end user account activation credentials from the end user;
provide a redemption control to the end user;
provide the digital payload to the end user in response to an activation of the redemption control; and
modify the database to indicate that the digital payload linked to the unique identifier is redeemed.

16. The controlled digital payload distribution system of claim 15, wherein the digital payload comprises:
a redeemable voucher, wherein the redeemable voucher is redeemable for a 1%-100% purchase price discount for a product or service;
a digital asset, the digital asset comprising one or more of an audio, video, or software asset.

17. The controlled digital payload distribution system of claim 15, wherein the unique identifier comprises a QR code, a bar code, an alphanumeric string, or an RFID tag.

18. The controlled digital payload distribution system of claim 15, wherein the tangible article comprises apparel, luggage, or a pet collar.

19. The controlled digital payload distribution system of claim 15, wherein the controlled digital payload distribution system is configured to:
receive the unique identifier when the digital payload is unredeemable, comprising:
receiving the unique identifier without end user account activation credentials; or
receiving the unique identifier after the digital payload is redeemed; and
provide one or more secondary digital payloads to an end user in response to receiving the unique identifier when the digital payload is unredeemable.

20. The controlled digital payload distribution system of claim 15, wherein the controlled digital payload distribution system is configured to:
receive custom end user account content for the end user account;
link the unique identifier to the end user account; and
provide the custom end user account content to an end user in response to receiving the unique identifier after the digital payload linked to the unique identifier is redeemed.

21. The controlled digital payload distribution system of claim 20, wherein the controlled digital payload distribution system is configured to provide one or more secondary digital payloads along with the custom end user account content.

22. The controlled digital payload distribution system of claim 15, wherein the controlled digital payload distribution system is configured to provide a customer account user interface adapted to receive the digital payload.

23. The controlled digital payload distribution system of claim 22, wherein the controlled digital payload distribution system is configured to provide the unique identifier in the customer account user interface.

24. The controlled digital payload distribution system of claim 22, wherein the customer account user interface is adapted to provide one or more selectable product lines of tangible articles, one or more selectable batches of tangible articles for at least one of the product lines, and end user information for at least one of the batches.

25. The controlled digital payload distribution system of claim 15, further comprising providing an end user account user interface comprising selectable tangible articles and/or selectable categories of tangible articles corresponding to digital payloads redeemed by the end user.

26. The controlled digital payload distribution system of claim 15, wherein the controlled digital payload distribution system is configured to:
receive a subsequent digital payload for distribution to end user accounts associated with a previously redeemed digital payload; and
provide a redemption control to the end user accounts for redeeming the subsequent digital payload.

27. The controlled digital payload distribution system of claim 15, wherein the controlled digital payload distribution system is configured to:
receive a secondary digital payload;
generate a secondary unique identifier for application to the tangible article;
link the secondary digital payload to the secondary unique identifier in the database;
receive the secondary unique identifier from an end user, wherein the end user acquired the secondary unique identifier from the tangible article;
provide a redemption control to the end user; and
provide the secondary digital payload to the end user in response to an activation of the redemption control.
